(19) United States
(12) Patent Application Publication
(10) Pub. No.: US 2022/0335047 A1
(43) Pub. Date: Oct. 20, 2022

(54) SYSTEM AND METHOD FOR DYNAMIC MEMORY ALLOCATION FOR QUERY EXECUTION

(71) Applicant: Microsoft Technology Licensing, LLC, Redmond, WA (US)

(72) Inventors: Prabhas Kumar SAMANTA, Bengaluru (IN); Craig Steven FREEDMAN, Sammamish, WA (US); Anamika Abhoypada DAS, Bengaluru (IN)

(21) Appl. No.: 17/483,270

(22) Filed: Sep. 23, 2021

Related U.S. Application Data
(60) Provisional application No. 63/176,028, filed on Apr. 16, 2021.

(51) Int. Cl. G06F 16/2453; G06F 11/34; G06F 16/2455

(52) U.S. Cl. CPC G06F 16/24542; G06F 11/3419; G06F 16/24552; G06F 16/24539

(57) ABSTRACT

Methods, systems, apparatuses, and computer-readable storage mediums described herein are directed to dynamic memory allocation for query execution. A memory grant engine is configured to analyze query runtime execution statistics of instances of a query to detect whether memory allocation operations performed for the query in accordance with a first memory allocation policy (e.g., a last used grant-based policy) changes across executions of that query. Upon detecting such a pattern, the engine dynamically switches to utilizing a second memory allocation policy, such as a percentile-grant based policy. In accordance with such a policy, the engine determines an amount of memory space to be allocated for subsequent instances of the query based on an analysis of query runtime execution statistics of previous instances of the query. The determined amount of memory space is configured to satisfy a predetermined percentile value of the previous instances of the query.

### CROSS-REFERENCE TO RELATED APPLICATION(S)

This application claims priority to U.S. Provisional Patent Application No. 63/176,028 entitled “MEMORY GRANT FEEDBACK,” and filed on Apr. 16, 2021, the entirety of which is incorporated by reference herein.

### BACKGROUND

Many modern relational database engines rely on cost-based query optimizations, where memory space is allocated (or granted) for the query using a query operator's estimated row cardinality and average row size. Estimations made during optimization can be incorrect for various reasons and can result in significant memory grant misestimation. Such misestimation can result in excessive memory grant sizes and reduced concurrency or insufficient memory grant sizes, which result in expensive hard disk utilization for query execution.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage mediums described herein are directed to dynamic memory allocation for query execution. For instance, a memory grant engine may be configured to analyze query runtime execution statistics of instances of a query to detect whether memory allocation operations performed for the query in accordance with a first memory allocation policy (e.g., a last used grant-based policy) changes across executions of that query. Such a pattern is indicative of an unstable memory requirement, which results in an inefficient usage of the memory. Upon detecting such a pattern, the memory grant engine dynamically switches to utilizing a second memory allocation policy, such as a percentile-grant based policy. In accordance with such a policy, the memory grant engine determines an amount of memory space to be allocated for subsequent instances of the query based on an analysis of query runtime execution statistics of previous instances of the query. The determined amount of memory space is configured to satisfy a predetermined percentile value of the previous instances of the query.

Further features and advantages, as well as the structure and operation of various examples, are described in detail below with reference to the accompanying drawings. It is noted that the ideas and techniques are not limited to the specific examples described herein. Such examples are presented herein for illustrative purposes only. Additional examples will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a networked system for determining a memory allocation policy for query execution, according to an example embodiment.

FIG. 2 shows a block diagram of system for determining a memory allocation policy for query execution, according to another example embodiment.

FIG. 3 shows a flowchart for determining a memory allocation policy and executing a query in accordance with the memory allocation policy, according to an example embodiment.

FIG. 4 is a block diagram of a system configured to determine a memory allocation policy and execute a query in accordance with the memory allocation policy, according to an example embodiment.

FIG. 5 shows a flowchart for persisting determined memory space allocation amounts, according to an example embodiment.

FIG. 6 is a block diagram of a system configured to persist memory space allocation amounts for query execution plans, according to an example embodiment.

FIG. 7 shows a block diagram of an example computing device that may be used to implement embodiments.

The features and advantages of embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially,” “approximately,” and “about” modifying a condition or relationship characteristic of a feature or features of an embodiment of the disclosure, are understood to mean that the condition or characteristic is defined to be within tolerances that are acceptable for operation of the embodiment for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures and drawings described herein can be spatially arranged in any orientation or manner. Additionally, the drawings may not be provided to scale, and orientations or organization of elements of the drawings may vary in embodiments.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Implementations

The embodiments described herein are directed to dynamic memory allocation for query execution. For instance, a memory grant engine may be configured to analyze query runtime execution statistics of instances of a query to detect whether memory allocation operations performed for the query in accordance with a first memory allocation policy (e.g., a last used grant-based policy) changes across executions of that query. Such a pattern is indicative of an unstable memory requirement, which results in an inefficient usage of the memory. Upon detecting such a pattern, the memory grant engine dynamically switches to utilizing a second memory allocation policy, such as a percentile-grant based policy. In accordance with such a policy, the memory grant engine determines an amount of memory space to be allocated for subsequent instances of the query based on an analysis of query runtime execution statistics of previous instances of the query. The determined amount of memory space is configured to satisfy a predetermined percentile value of the previous instances of the query.

Subsequent queries received and that are to be processed may be monitored for identification of instances of the same or similar queries to which the memory allocation policy change was determined. An amount of memory is allocated for such subsequent queries in accordance with the second memory allocation policy. A query may be similar semantically, based on semantic equivalency, and/or like, in whole or in part, with respect to another query as described in additional detail herein.

The embodiments described herein optimize memory allocation for query execution. For instance, if more memory space is allocated than actually needed, then other operations, such as other query executions, are starved from the memory, as such memory is inaccessible for the query. For instance, other queries are forced to execute with less than an optimal amount of memory or are forced to wait to execute if an insufficient amount of memory is available to grant. On the other hand, if too little memory space is allocated, then the performance for the query execution suffers, as query execution in such cases requires access to a storage device, such as a hard disk, a solid disk drive, etc., to compensate for the under-allocated memory space (also referred to as “data spillage”). The embodiments herein determine a more effective memory allocation policy to be utilized for allocating compute resources for a given query execution plan, which accurately estimates the amount of memory space to be allocated for the query. Such techniques minimize excessive memory space allocation and prevent data spillage.

These and further embodiments will be described in further detail below, and in the Sections and Subsections that follow.

A. Memory Allocation Policy Determination for Query Execution

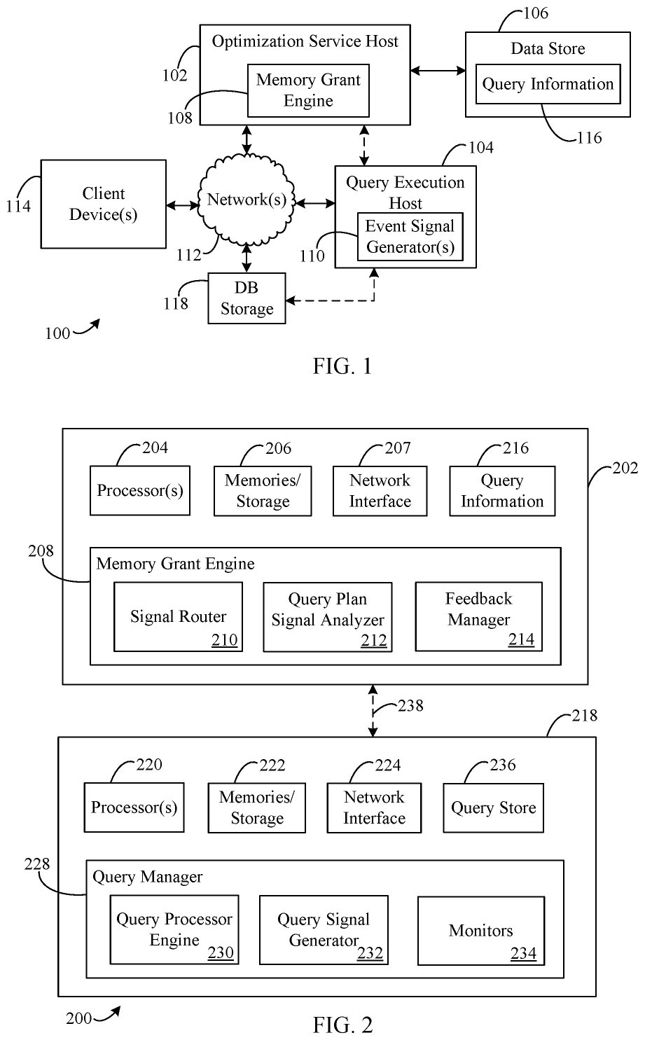

Systems, devices, and apparatuses may be configured in various ways to perform their functions for determining a memory allocation policy to be utilized during query processing against databases, such as relational databases. For instance, FIG. 1 is a block diagram of a networked system 100, according to embodiments. System 100 is configured to determine a memory allocation (or “grant”) policy to be utilized when executing a query of a query execution plan, according to embodiments. As shown in FIG. 1, system 100 includes an optimization service host 102, one or more client devices 114, and a query execution host 104. In embodiments, optimization service host 102, query execution host 104, and client device(s) 114 may communicate with each other over a network 112. It should be noted that various numbers of host devices and/or client devices may be present in various embodiments. Additionally, any combination of the components illustrated in FIG. 1 may be present in system 100, according to embodiments.

As noted above, optimization service host 102, client device(s) 114, and query execution host 104 are communicatively coupled via network 112. Network 112 may comprise any type of communication links that connect computing devices and servers such as, but not limited to, the Internet, wired or wireless networks and portions thereof, point-to-point connections, local area networks, enterprise networks, and/or the like. In some embodiments, e.g., for legacy recordings, data may also be transferred, in addition to or in lieu of, using a network, on physical storage media, between client device(s) 114, query execution host 104, and/or optimization service host 102.

Query execution host 104 may comprise one or more server computers or computing devices, which may include one or more distributed or “cloud-based” servers. In embodiments, query execution host 104 may be associated with, or may be a part of, a cloud-based service platform such as Microsoft® Azure® from Microsoft Corporation of Redmond, Wash. In some embodiments query execution host 104 may comprise one or more on-premises servers. Various systems/devices such as optimization service host 102 and/or client devices such as client device(s) 114 may be configured to provide data and information, including queries, associated with query execution/processing to query execution host 104 via network 112. Query execution host 104 may be configured to execute queries provided from client device(s) 114 via network 112, to monitor runtime statistics, monitor query parameters, etc., during the execution of queries, and to provide such information to optimization service host 102. As illustrated, query execution host 104 includes one or more event signal generators 110 that may be configured to generate the information and/or event signals provided to optimization service host 102 to perform memory allocation policy determinations and feedback operations described herein. Further details regarding event signal generation and query execution monitoring are provided below.

It should be noted that as described herein, embodiments of query execution host 104 are applicable to any type of system where queries are received, e.g., over a network, for execution against one or more databases (including data sets). One example noted above is where query execution host 104 is a “cloud” implementation, application, or service in a network architecture/platform. A cloud platform may include a networked set of computing resources, including servers, routers, etc., that are configurable, are shareable, provide data security, and are accessible over a network such as the Internet. Cloud applications/services such as for machine learning may run on these computing resources, often atop operating systems that run on the resources, for entities that access the applications/services over the network. A cloud platform may support multi-tenancy, where cloud platform-based software services multiple tenants, with each tenant including one or more users who share common access to software services of the cloud platform. Furthermore, a cloud platform may support hypervisors implemented as hardware, software, and/or firmware that run virtual machines (emulated computer systems, including operating systems) for tenants. A hypervisor presents a virtual operating platform for tenants.

System 100 also includes a database (DB) storage 118 that stores one or more databases or data sets against which query execution host 104 executes queries. DB storage 118 may be communicatively coupled to query execution host 104 via network 112, as shown, may be a portion of query execution host 104, may be an external storage system of query execution host 104, or may be a cloud storage system, in different embodiments.

Client device(s) 114 may be any type or combination of computing device or computing system, including a terminal, a personal computer, a laptop computer, a tablet device, a smart phone, a personal digital assistant, and/or the like, including internal/external storage devices, that may be utilized to generate and/or provide queries for execution by query execution host 104. In embodiments, client device(s) 114 may be used by various types of users, such as an administrator, support staff agents, customers, clients, and/or the like to run queries against databases. Client device(s) 114 may include one or more user interfaces (UIs) that may be stored and executed thereby, or that may be provided from query execution host 104.

Optimization service host 102 may comprise one or more server computers or computing devices, which may include one or more distributed or “cloud-based” servers, as described above. Optimization service host 102 may include a memory grant engine 108 that is configured to route event signals to one or more analyzers for feedback determinations (e.g., generation and provision of memory allocation policy change notifications), as described in further detail herein. Optimization service host 102 may be remote to query execution host 104 or may be a part of query execution host 104, in embodiments. Optimization service host 102 may also be configured to communicate with query execution host 104 by connections other than, or in addition to, network 112.

System 100 may include a storage shown as a data store 106 that may be a stand-alone storage system, and/or may be internally or externally associated with optimization service host 102. In embodiments, data store 106 may be communicatively coupled to other systems and/or devices via network 112. That is, data store 106 may be any type of storage device or array of devices, and while shown as being communicatively coupled to optimization service host 102, may be networked storage that is accessible via network 112. Additional instances of data store 106 may be included in addition to, or in lieu of, the embodiment shown. Data store 106 may be an intermediate feedback storage and may be configured to store different types of data/information such as query information 116, including but not limited to, metadata related to queries, query processing/executions data, query plan analyses, query runtime execution statistics, percentile values utilized for memory allocation calculations, feedback values determined utilizing different memory allocation policies, and/or the like, as described herein. In accordance with an embodiment, data store 106 may comprise a non-volatile memory (e.g., non-volatile random access memory (NVRAM), hard disks, optical discs, solid-state drives, etc. In embodiments, data store 106 and DB storage 118 may be part of the same storage system.

Cardinality estimation (CE), as described herein, is a phase within query optimization and compilation which involves the prediction of how many rows of data a tree of query operators is likely to process. CE is used by a query optimizer associated with a query processor/engine to generate an optimal or optimized query execution plan, and when cardinality estimates are accurate, among other things, the query optimizer produces an appropriate plan. However, when row estimates are significantly skewed compared to actual row counts or when row size estimates are incorrect, this can result in query performance issues; in particular, memory grant misestimates. Based on the generated query execution plan, compute resources, such as memory or memory space, are granted or allocated, which are utilized during execution of the query of the query execution plan. The performance of system 100 may be affected based on the amount of memory allocated. For instance, if more memory space is allocated than actually needed, then other operations, such as other query executions, are starved from the memory, as such memory is inaccessible for the query. For instance, other queries are forced to execute with less than an optimal amount of memory or are forced to wait to execute if an insufficient amount of memory is available to grant. On the other hand, if too little memory space is allocated, then the performance for the query execution suffers, as such query execution in such cases require access to the hard disk to compensate for the under-allocated memory space (also referred to as “data spillage”).

The embodiments herein determine a more effective memory allocation (or “grant”) policy to be utilized for allocating compute resources for a given query execution plan. Host devices such as optimization service host 102 and/or query execution host 104 may be configured in various ways for determining a memory allocation policy to be applied with respect to query execution. For instance, referring now to FIG. 2, a block diagram of a system 200 is shown for determining a memory allocation policy for query execution with respect to databases, e.g., relational databases, according to an example embodiment. System 200 may be an embodiment of system 100 of FIG. 1. System 200 is described as follows.

System 200 includes a computing device 202, which may be an embodiment of optimization service host 102 of FIG. 1, and a computing device 218 which may be an embodiment of query execution host 104 of FIG. 1, each of which may be any type of server or computing device, including “cloud” implementations, as mentioned elsewhere herein, or as otherwise known. As shown in FIG. 2, computing device 202 and computing device 218 may each respectively include one or more of processors (“processor”) 204 and one or more of processors (“processor”) 220, one or more of memories and/or other physical storage devices (“memory”) 206 and one or more memories and/or other physical storage devices (“memory”) 222, as well as one or more network interfaces (“network interface”) 207 and one or more network interfaces (“network interface”) 224. Computing device 202 may include a memory grant engine 208 that may be configured to analyze query runtime execution statistics and determine a memory allocation policy to be utilized for query execution, and computing device 218 may include a query manager 228 that may be configured to implement memory allocation policies for query execution, to execute queries, and to monitor/generate query runtime execution statistics and information for use by memory grant engine 208. Memory grant engine 208 is an example of memory grant engine 108, as shown in FIG. 1.

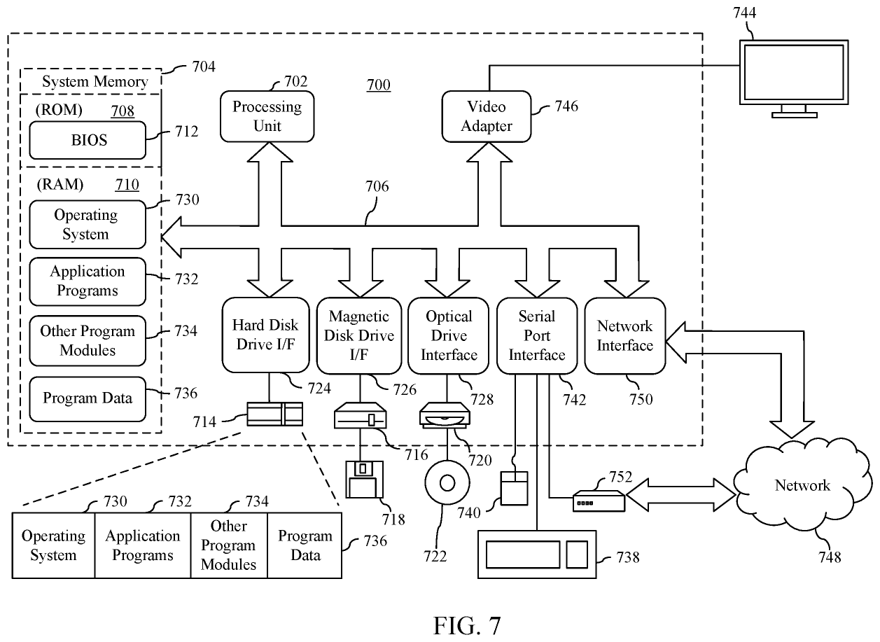

System 200 may also include additional components (not shown for brevity and illustrative clarity) including, but not limited to, components and subcomponents of other devices and/or systems herein, as well as those described below with respect to FIG. 7, such as an operating system, etc.

Processor 204/processor 220 and memory 206/memory 222 may respectively be any type of processor circuit(s) and memory that is described herein, and/or as would be understood by a person of skill in the relevant art(s) having the benefit of this disclosure. Processor 204/processor 220 and memory 206/memory 222 may each respectively comprise one or more processors or memories, different types of processors or memories (e.g., a cache for query processing and/or storing feedback values determined utilizing different memory allocation policies (as described herein), remote processors or memories, and/or distributed processors or memories. Processor 204/processor 220 may be multi-core processors configured to execute more than one processing thread concurrently. Processor 204/processor 220 may comprise circuitry that is configured to execute computer program instructions such as, but not limited to, embodiments of memory grant engine 208 and/or query manager 218, which may be implemented as computer program instructions for determining a memory grant policy to be utilized for query execution against databases, etc., as described herein.

Memory 206/memory 222 may include data store 106 of FIG. 1 in embodiments, and may be configured to store such computer program instructions/code, as well as to store other information and data described in this disclosure including, without limitation, query information 216 (which may be an embodiment of query information 116 of FIG. 1) such as queries, query statistics, information on query processing/executions, query plan analyses, metadata, determined memory space allocation amounts, feedback values determined utilizing different memory allocation policies (as described herein), etc., and/or the like. In embodiments, memory 222 may comprise DB storage 118 of FIG. 1, or computing device 202 may otherwise (internally or externally) utilize DB storage 118.

Network interface 207/network interface 224 may be any type or number of wired and/or wireless network adapter, modem, etc., configured to enable system 200, including computing device 202 and computing device 218, to communicate with other devices and/or systems over a network, such as communications between computing device 202 and computing device 218, shown as a connection 238, as well as communications between systems and computing devices with other systems/devices utilized in a network as described herein (e.g., client device(s) 114, and/or data store 106) over a network such as network 112 as described above with respect to FIG. 1.

Computing device 218 of system 200 may also include a query store 236. Query store 236 may be a part of memory 222 in embodiments, and is configured to store currently executing queries and previously executed queries, as well as query plans for executing such queries.

Memory grant engine 208 of computing device 202 includes a plurality of components for performing the functions and operations described herein for determining a memory grant policy. For instance, memory grant engine 208 may be configured to analyze query runtime execution statistics and provide memory allocation policy change notifications to query manager 228. As illustrated, memory grant engine 208 includes a signal router 210, a query plan signal analyzer 212, and a feedback manager 214.

Signal router 210 is configured to route signals such as event signals that are received from query manager 228 to query plan signal analyzer 212. Query plan signal analyzer 212 is configured to analyze query execution runtime statistics and/or other query information of the event signals and determine a predetermined pattern of memory allocations with respect to the same or similar query execution plans. Based on the determined pattern, query plan signal analyzer 212 is configured to determine a memory allocation policy to be utilized for subsequent execution of the query of the query execution plan. For instance, when a query is to be executed, query plan signal analyzer 212 may be configured determine the actual amount of memory space required for execution of a previous instance of the query and the amount of memory space allocated for execution of the previous instance of the query. Query plan signal analyzer 212 compares the actual amount of memory space required to the amount of memory space allocated. If the difference between the actual amount of memory space required and the amount of memory allocated reaches or exceeds a predetermined threshold, feedback manager 214 may determine that the amount of memory allocated was incorrect and may provide a policy change notification to query manager 228 of query host 218 to utilize a first memory allocation policy. The policy change notification specifies the determined memory allocation policy to query manager 228.

In accordance with an embodiment, the first memory allocation policy a last used grant (LUG)-based policy. In accordance with the LUG-based policy, the amount of memory space to be allocated for a given query is based on the determined actual amount of memory space required for the previous execution of that same or similar query. For instance, the amount of memory space to be allocated for the query may be the same as the determined actual amount of memory required for the previous execution of that same or similar query. In another example, the amount of memory space to be allocated for the query may be based on a combination (e.g., an addition) of the determined actual amount of memory space required for the previous execution of that same or similar query and a predetermined buffer value. For instance, the buffer value represents an extra amount of memory space to be added to the determined actual of memory space required for the previous execution of same or similar query.

After switching to utilizing the first memory allocation policy, memory grant engine 208 may continue to analyze the query execution runtime statistics of future instances of that query (or similar queries) to determine whether a more effective memory allocation policy should be utilized. In accordance with an embodiment, query plan signal analyzer 212 is configured to detect a pattern that is indicative of an unstable memory requirement. For instance, query plan signal analyzer 212 may be configured to determine whether the amount of memory allocated for a given query, in accordance with the first memory allocation policy, changes across executions of that query. A memory allocation for a given query that frequently changes from one execution to another execution is indicative of an unstable memory allocation.

In accordance with an embodiment, query plan signal analyzer 212 is configured to determine a number of times that the amount of memory space required for execution of a given query differs from the amount of memory space allocated for execution of the query by a predetermined threshold. For instance, query plan signal analyzer 212 may determine whether the difference (e.g., a positive or negative difference) between the amount of memory space required and the amount of memory space allocated is at least a certain memory space amount (e.g., 500 MB, 1 GB, etc.) or if the difference is a certain percentage above or below of the allocated memory space. If the number of times that the amount of memory space required for execution differs from the amount of memory space allocated reaches a predetermined threshold (i.e., memory space was misallocated a certain number of times for a given query), then query plan signal analyzer 212 may determine that memory allocation for the query is unstable, and feedback manager 214 may provide a notification to query host 218 to utilize a second memory allocation policy. In accordance with an embodiment, the predetermined threshold is two (that is, the memory space was misallocated two times for a given query); although, it is noted that this value for the predetermined threshold is purely exemplary and that other threshold values may be utilized.

In accordance with an embodiment, the second memory allocation policy is a percentile grant-based policy. In accordance with the percentile grant-based policy, the amount of memory allocated for a query is based on a percentile value of the actual amount of memory space required during past executions of the query. In accordance with an embodiment, the percentile value is 95 percent; although, it is noted that the embodiments described herein are not so limited and that other percentile values may be utilized. In accordance with such an embodiment, the amount of memory space allocated for a query may be equal to the amount of memory space allocated that would satisfy 95% of past executions for that query. In accordance with another embodiment, the determined amount of memory may be increased in accordance with a predetermined buffer value. The buffer value, as described above, represents an extra amount of memory space to be added to the determined amount of memory space. The determined amount of memory space allocated may be cached in a memory (e.g., memories 206/222) and/or stored in data store 106.

Once queries are executed in accordance with the second memory allocation policy, query runtime execution statistics are continued to be monitored for a subsequent instances of the query, and the amount of memory space allocated for subsequent query execution plans is updated based on query runtime execution statistics of the subsequent instances of the query. For instance, if the query runtime execution statistics for a subsequent instance of the query indicates that the actual amount of memory required to execute that instance is greater than the amount of memory space allocated (e.g., with the added buffer value), the amount of memory space allocated for the next instance of the query execution plan for that query may be increased to maintain the targeted percentile. If the query runtime executions statistics for a subsequent instance of the query indicates that the actual amount of memory space required to execute that instance is less than the amount of memory space allocated, the amount of memory space allocated for the next instance of the query execution plan of the query may be decreased to maintain the targeted percentile. If the query runtime executions statistics for a subsequent instance of the query indicates that the actual amount of memory space required to execute that instance is equal to the amount of memory space allocated, the amount of memory allocated for the next instance of the query execution plan of the query may not be changed.

In embodiments, the determined memory allocation policy may be applied to the same query or to similar queries for their subsequent execution.

Query manager 228 of computing device 218 includes a plurality of components for performing the functions and operations described herein for memory allocation policy determination. For example, query manager 228 may be configured to implement a memory allocation policy determined by memory grant engine 208, to execute queries, and to monitor/generate query statistics and information for use by memory grant engine 208. Query manager 228 includes a query processor engine 230, a query signal generator 232, and one or more engine/query monitors (monitors) 234. In some implementations, monitors 234 may comprise a portion of query signal generator 232, or vice versa.

In embodiments, a portion of query manager 228 may be executing at, or communicating with, client device(s) 114 such that execution of queries can be monitored by monitors 234 and policy change notifications may be provided to users via a UI prior to query execution initialization.

Query processor engine 230 is configured analyze query plans generated for queries, allocate compute resources, such as memory, to be utilized for execution of the query, and/or execute queries against databases according to their respective query execution plans and memory space allocated therefor. Query processor engine 230 may be software and/or hardware utilized in conjunction with processor 220. Query signal generator 232 is configured to generate event signals with runtime statistics for executing queries. The event signals are provided to an optimization host, e.g., computing device 202 comprising memory grant engine 208, as noted above. Initially, query processor engine 230 may operate in accordance with a default memory allocation policy, where the memory allocated for a particular query execution plan for a query to be executed is based on analysis of the query execution plan generated for that query.

Monitors 234 may comprise one or more monitors for databases, query engines, and/or query execution. One or more of monitors 234 for databases, query engines, and query execution may monitor runtime performance and operations when queries are executed in order to provide information to query signal generator 232. For instance, for each query executed, one or more of monitors 234 may be configured to monitor actual memory usage with respect to the query (i.e., how much memory was actually required and utilized to execute the query). One or more of monitors 234 may also include a monitor to observe incoming queries to computing device 218 and query manager 228 to determine if a prior executed query for which a memory grant policy was determined or other queries similar to the prior executed query are received. In such cases, the memory grant policy determined for that query may be applied for execution.

While shown separately for illustrative clarity, in embodiments, one or more of the components of memory grant engine 208 and/or query manager 228 may be combined together and/or as a part of other components of system 200. In some embodiments, less than all of the components of memory grant engine 208 and/or query manager 228 illustrated in FIG. 2 may be included. In software implementations, one or more components of memory grant engine 208 and/or query manager 228 may be stored in memory 206 and/or memory 222, respectively, and may be executed by processor 204 and/or 220, respectively.

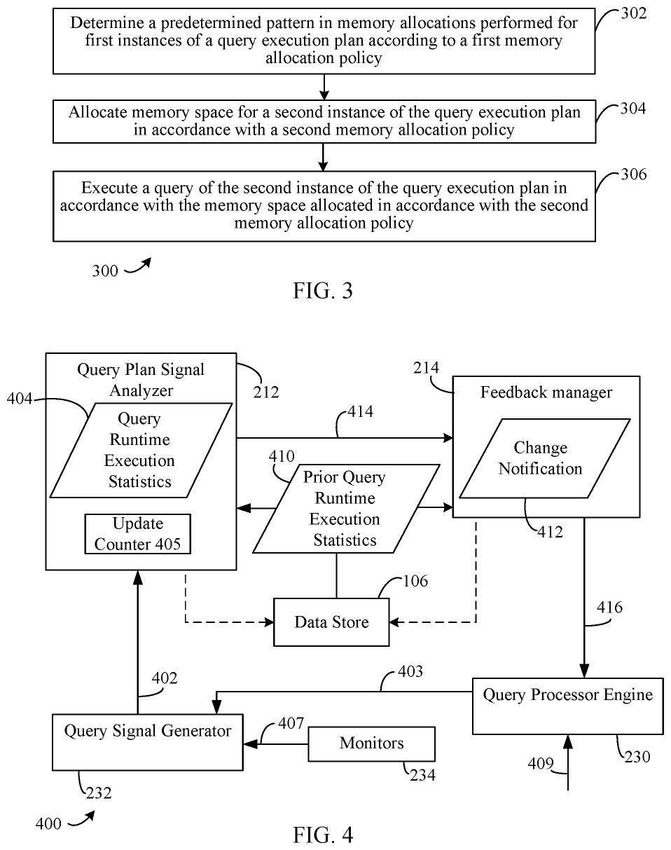

As noted above for FIGS. 1 and 2, embodiments herein provide for determining a memory allocation (or “grant”) policy to be utilized for query execution. System 100 of FIG. 1 and system 200 of FIG. 2 may each be configured to perform such functions and operations. For instance, FIG. 3 will now be described. FIG. 3 shows a flowchart 300 for determining a memory allocation policy and executing a query in accordance with the memory allocation policy, according to example embodiments. In an embodiment, flowchart 300 may be implemented by a system 400, as shown in FIG. 4. FIG. 4 is a block diagram of system 400, which is configured to determine a memory allocation policy and execute a query in accordance with the memory allocation policy in accordance with an example embodiment. As shown in FIG. 4, system 400 includes data store 106, query plan signal analyzer 212, feedback manager 214, query processor engine 230, query signal generator 232, and monitors 234.

Flowchart 300 begins at step 302. In step 302, a predetermined pattern in memory allocations performed for instances of a query execution plan according to a first memory allocation policy is determined. For example, with reference to FIG. 4, query processor engine 230 may determine a predetermined pattern in memory allocations performed for first instances of a query execution plan according to a first memory allocation policy. For instance, with reference to FIG. 4, query processor engine 230 may determine the predetermined pattern based on receiving a notification signal 416 from feedback manager 214. Notification signal 416 may comprise a change notification 412, which indicates that query processor engine 230 is to utilize the second memory allocation policy. Step 302 may occur after execution of a query (e.g., query 409 received from a client device (e.g., client device(s) 114, as shown in FIG. 1)) associated with the query execution plan.

Feedback manager 214 is configured to send change notification 412 based on an analysis performed by query plan signal analyzer 212 of query runtime execution statistics for the query associated with the query execution plan. For instance, query processor engine 230 may determine the memory space allocated for the query execution plan of query 409 and provide a notification 403 indicating as such to query signal generator 232. Monitors 234 are configured to determine, for each instance of query 409 processed and executed by query processor engine 230, the actual memory required/utilized to execute the instance of query 409 and provides such statistics to query signal generator 232 via a notification 407. Query signal generator 232 is configured to generate an event signal 402 that comprises the actual memory space required/utilized for execution of query 409 and the amount of memory space allocated for query 409 before execution of query 409. Event signal 402 may also comprise additional information, including, but not limited to, the query that was executed, query parameters of the query, the query execution plan utilized to execute the query (or indicia thereof), etc. Query signal generator 232 provides event signal 402 to query plan signal analyzer 212. Query plan signal analyzer 212 analyzes runtime statistics from event signal 402 (shown as query runtime execution statistics 404), and other information therein according to embodiments, to determine a memory allocation policy to be allocated for subsequent instances of the query execution plan. Query plan signal analyzer 212 may be configured to store query runtime execution statistics 404 and/or any associated information described above in data store 106.

Query parameters may be based on query plans/models and may include, but are not limited to, data correlation, join types, indexing, containment types, interleaved optimizations for a table-valued function, a deferred compilation of runtime objects such as table variables, etc., and may be determined based on information associated with the runtime statistics, according to embodiments.

Query plan signal analyzer 212 may perform the foregoing operations for each query received via a client device (e.g., client device(s) 114, as shown in FIG. 1) and that is to be executed by query processor engine 230. Accordingly, data store 106 may store query runtime execution statistics for previously-executed queries (shown as prior query runtime execution statistics 410).

Query plan signal analyzer 212 is configured to detect a pattern that is indicative of an unstable memory requirement. In accordance with an example embodiment, query plan signal analyzer 212 is configured to determine whether the amount of memory space required for execution for query 409 differs from the amount of memory space allocated prior to execution of query 409 by a predetermined threshold. Query plan signal analyzer 212 may determine whether the difference (e.g., a positive or negative difference) between the amount of memory space required and the amount of memory space allocated is at least a certain memory space amount (e.g., 500 MB, 1 GB, etc.) or if the difference is a certain percentage above or below of the allocated memory space. If query plan signal analyzer 212 determines that the amount of memory space utilized for execution for query 409 differs from the amount of memory space required for the query execution plan of the query by the predetermined threshold, query plan signal analyzer 212 may increase an update counter 405.

Query plan signal analyzer 212 continues to perform the foregoing operations for each instance of query 409 that is executed. In the event that the value of update counter 405 reaches a predetermined threshold (e.g., 2), query plan signal analyzer 212 may determine that a pattern indicative of an unstable memory requirement for query 409 has been detected. It is noted, however, that the embodiments described herein are not so limited and that other techniques may be utilized for detecting an unstable memory requirement for a query. In response, query plan signal analyzer 212 may provide a notification 414 to feedback manager 214. Responsive to receiving notification 414, feedback manager 214 may provide change notification 412 to query process engine via notification signal 416.

In accordance with an embodiment, feedback manager 214 may determine the amount of memory to be allocated for a subsequent instance of query 409 and provide the determined amount of memory via policy change notification 412.

In accordance with an embodiment, the pattern may be determined responsive to determining that an actual amount of memory space required for at least two of the first instances of the query execution plan is greater than memory space allocated for the at least two of the first instances of the query execution plan by a predetermined threshold. For instance, with reference to FIG. 3, query plan signal analyzer 212 may determine that an actual amount of memory space required for at least two instances of the query execution plan (i.e., the queries thereof) is greater than the memory space allocated for the at least first instances of the query execution plan by a predetermined threshold (i.e., update counter 405 has been incremented twice, and thus reached an exemplary predetermined threshold).

In accordance with another embodiment, the pattern may be determined responsive to determining that an actual amount of memory space required for at least two of the first instances of the query execution plan is less than memory space allocated for the at least two of the first instances of the query execution plan by a predetermined threshold. For instance, with reference to FIG. 3, query plan signal analyzer 212 may determine that an actual amount of memory space required for at least two instances of the query execution plan is less than the memory space allocated for the at least first instances of the query execution plan by a predetermined threshold (i.e., update counter 405 has been incremented twice, and thus reached an exemplary predetermined threshold).

In accordance with a further embodiment, the pattern may be determined responsive to determining that an actual amount of memory space required for at least one first instance of the query execution plan is less than the memory space allocated for the at least one first instance of the query execution plan by a predetermined threshold and an actual amount of memory space required for at least another first instance of the query execution plan is greater than the memory space allocated for the at least another first instance of the query execution plan by the predetermined threshold. For instance, with reference to FIG. 3, query plan signal analyzer 212 may determine that an actual amount of memory space required for an instance of the query execution plan is less than the memory space allocated for the instance of the query execution plan by a predetermined threshold, and an actual amount of memory space required for another instance of the query execution plan is greater than the memory space allocated for the other instance of the query execution plan by the predetermined threshold (i.e., update counter 405 has been incremented twice, and thus reached an exemplary predetermined threshold).

In accordance with an embodiment, the first memory allocation policy is a last used grant-based policy, in which memory space allocated for a particular instance of the first instances of the query execution plan is based on the actual amount of memory space required for an instance of the first instances of the query execution plan that is prior to the particular instance, and the second memory allocation policy is a percentile grant-based policy, in which memory space allocated for the second instance of the query execution plan is based on a percentile value of the actual amount of memory space required for each of the first instances of the query execution plan. For example, when receiving a query (e.g., query 409) when operating in accordance with the first memory allocation policy, query plan signal analyzer 212 may retrieve prior query runtime execution statistics 410 for the previous instance of query 409 that was executed from data store 106. Query plan signal analyzer 212 may analyze prior query runtime execution statistics 410 to determine the actual amount of memory required for a prior instance of the query and provides the determined actual memory to feedback manager 214 via notification 414. Feedback manager 214 may provide the determined actual memory to query processor engine via notification 416. In another example, when receiving a query when operating in accordance with the second memory allocation policy, query plan signal analyzer 212 may retrieve prior query runtime execution statistics 410 for some or all previous instances of the query from data store 106. Query plan signal analyzer 212 may analyze prior query runtime execution statistics 410 for such previous instances of the query and determine the amount of memory to be allocated based on a percentile value (e.g., 95%). For instance, query plan signal analyzer 212 may determine that the amount of memory space to be allocated for the query may be equal to the amount of memory space that would satisfy 95% of the previous instances of that query. The determined amount of memory space may be increased in accordance with a predetermined buffer value. The buffer value, as described above, represents an extra amount of memory space to be added to the determined amount of memory space.

At step 304, responsive to the determination of step 302, memory space is allocated for a second instance of the query execution plan in accordance with a second memory allocation policy. For example, with reference to FIG. 4, query processor engine 230 may generate a query execution plan for a subsequent instance of query 409. Query processor engine 230 may be configured to allocate memory space (e.g., memory space of memories/storage 222, shown in FIG. 2) for the query execution plan in accordance with a second memory allocation policy. The amount of memory space to be allocated in the accordance with the second memory allocation policy may be provided via change notification 412.

At step 306, a query of the second instance of the query execution plan is executed in accordance with the memory space allocated in accordance with the second memory allocation policy. For example, with reference to FIG. 4, query processor engine 230 executes the subsequent instance of query 409 (of the second instance of the query execution plan) in accordance with the memory space allocated in accordance with the second memory allocation policy.

In accordance with one or more embodiments, a value based on at least the amount of memory space allocated for the second instance of the query execution plan is stored in a non-volatile memory. For example, with reference to FIG. 4, a value based on at least the amount of memory space allocated for the second instance of the query execution plan is stored in data store 106, which may be a non-volatile memory. The value may specify the amount of memory space allocated for the second instance of the query execution plan. The associated query execution plan and/or query may also be stored in association with the value in data store 106. Still further, an identifier of the memory allocation policy utilized to determine the amount of memory space allocated may be stored in data store 106. As will be described below in Subsection B, this avoids having to recalculate the amount of memory space allocated for future instances of the query execution plan in the event that determined amount of memory space is lost, for example, due to query recompilation or power loss.

In accordance with one or more embodiments, the value is further based on a combination of the amount of memory space allocated for the second instance of the query execution plan and a buffer value. For example, with reference to FIG. 4, query plan signal analyzer 212 may add a buffer value to the amount of memory space allocated for the second instance of the query execution plan and store the resulting value in data store 106.

B. Persistence of Memory Allocation Amount Determinations

Prior techniques store memory space allocation amounts as part of a cached plan. When a query is re-compiled, memory space allocation amounts are re-calculated using estimated cardinality. This might lead to wrong allocation estimates during execution. In addition, the correct memory allocations for a given query execution plan must be re-learned for the plan (which might take many executions using a percentile-based approach).

In accordance with an embodiment, the amount of memory space allocated in accordance with the second memory allocation policy is persisted in a non-volatile memory. But as each persistence call has an overhead in terms of resource utilization and time, it leads to an interesting problem to identify when persistence is required and most impactful. Ideally. whenever a new memory space allocation amount (also referred to as a “feedback value”) is determined in accordance with the second memory allocation policy (i.e., a percentile-based memory allocation policy), it can be stored or persisted in non-volatile memory. However, in practice most query execution plans have a stable memory allocation and thus experience little variation in grant requirement. As such, capturing and persisting the feedback value for each instance of a query execution plan leads to a huge number of persistence calls, which are costly.

In accordance with an embodiment, the determination to persist a determined memory space allocation amount depends on the stability of memory space allocations. For instance, query plan signal analyzer 212 may be configured to identify query execution plans having a memory space requirement that does not change much across executions based on an analysis of prior query runtime execution statistics 410. For such identified plans, the determined memory space allocation is increased in accordance with a predetermined buffer value to accommodate a little variation in memory space requirements. Persisting the memory space allocation amount (including the buffer value) is avoided, unless the net change across multiple executions goes beyond the allocated buffer.

When query plan signal analyzer 212 determines that the memory allocation requirement for a given query execution plan is unstable, the second memory allocation policy is utilized, as described above. With this approach, at the end of each query execution, the amount of memory space to be allocated for the next instance of the query is updated. However, the amount of memory space to be allocated is not persisted after each execution. In accordance with an embodiment, an upper threshold and a lower threshold may be established. The upper threshold represents an amount of memory space above the persisted allocated memory space amount, and the lower threshold represents an amount of memory space below the persisted allocated memory space amount. In accordance with such an embodiment, when a new feedback value is calculated after execution of the query, and the feedback value either reaches or exceeds the upper threshold or reaches or exceeds the lower threshold, the newly-calculated feedback value is persisted. The predetermined buffer value may be added to the newly-calculated feedback value before persisting to reduce the number of persistence calls for a slowly-increasing memory space requirement.

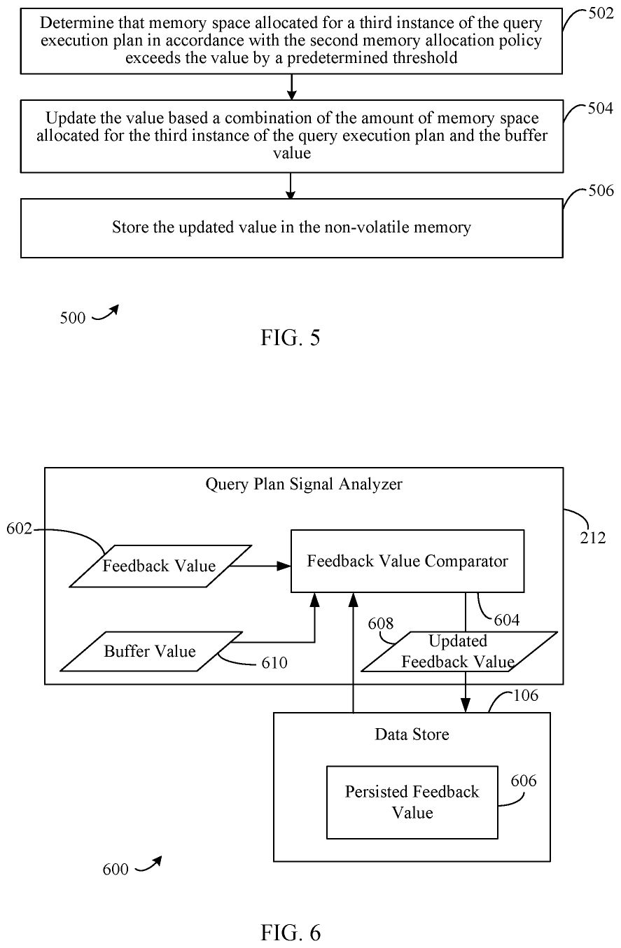

Accordingly, determined memory space allocation amounts (i.e., feedback values) may be persisted in many ways. For example, FIG. 5 shows a flowchart 500 for persisting determined memory space allocation amounts in accordance with an example embodiment. In an embodiment, flowchart 500 may be implemented by a system 600, as shown in FIG. 6. FIG. 6 is a block diagram of system 600, which is configured to persist memory space allocation amounts for query execution plans in accordance with the memory allocation policy in accordance with an example embodiment. As shown in FIG. 6, system 600 includes data store 106 and query plan signal analyzer 212.

Flowchart 500 begins at step 502. At step 502, a determination is made that memory space allocated for a third instance of the query execution plan in accordance with the second memory allocation policy exceeds the value by a predetermined threshold. For example, with reference to FIG. 6, query plan signal analyzer 212 is configured to determine the memory space allocated for a third instance of the query execution per embodiments described above in Subsection A. The memory space allocated is shown in FIG. 6 as feedback value 602. Feedback value comparator 604 of query plan signal analyzer 212 is configured to retrieve and compare the feedback value persisted in data store 106 (shown as persisted feedback value 606) to feedback value 602 and determine whether feedback value 602 exceeds persisted feedback value 606 by a predetermined threshold (e.g., whether feedback value 602 reaches or exceeds a lower threshold or an upper threshold as described above).

At step 504, responsive to the determination made at step 602, the value is updated based on a combination of the amount of memory space allocated for the third instance of the query execution plan and the buffer value. For example, with reference to FIG. 6, responsive to determining that feedback value 602 exceeds persisted feedback value 606 by a predetermined threshold, feedback value comparator 604 updates persisted feedback value based on a combination of feedback value 602 and a buffer value 610. For instance, feedback value comparator 606 adds buffer value 610 to feedback value 602.

At step 506, the updated value is stored in the non-volatile memory. For example, with reference to FIG. 6, feedback value comparator 604 stores the resulting value (shown as updated feedback value 608) in data store 106.

It is noted that feedback value 602 may comprise a plurality of different values, including, but not limited to, memory space allocation amounts for more than one prior instance of a query, an average of such memory space allocation amounts, a variation or standard deviation determined based on such memory space allocation amounts, or any other information that may be utilized to determine a memory space allocation amount in accordance with a percentile-based memory allocation policy.

### III. Example Computing Device Embodiments

Embodiments described herein may be implemented in hardware, or hardware combined with software and/or firmware. For example, embodiments described herein may be implemented as computer program code/instructions configured to be executed in one or more processors and stored in a computer readable storage medium. Alternatively, embodiments described herein may be implemented as hardware logic/electrical circuitry.

As noted herein, the embodiments described, including without limitation system 100 of FIG. 1, system 200 of FIG. 2, system 400 of FIG. 4, and system 600 of FIG. 6, along with any components and/or subcomponents thereof, as well as any flowcharts/flow diagrams described herein, including portions thereof, and/or further examples described herein, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Embodiments described herein may be implemented in one or more computing devices similar to a mobile system and/or a computing device in stationary or mobile computer embodiments, including one or more features of mobile systems and/or computing devices described herein, as well as alternative features. The descriptions of mobile systems and computing devices provided herein are provided for purposes of illustration, and are not intended to be limiting. Embodiments may be implemented in further types of computer systems, as would be known to persons skilled in the relevant art(s).

FIG. 7 depicts an exemplary implementation of a computing device 700 in which embodiments may be implemented. For example, embodiments described herein may be implemented in one or more computing devices similar to computing device 700 in stationary or mobile computer embodiments, including one or more features of computing device 700 and/or alternative features. The description of computing device 700 provided herein is provided for purposes of illustration, and is not intended to be limiting. Embodiments may be implemented in further types of computer systems and/or game consoles, etc., as would be known to persons skilled in the relevant art(s).

As shown in FIG. 7, computing device 700 includes one or more processors, referred to as processor circuit 702, a system memory 704, and a bus 706 that couples various system components including system memory 704 to processor circuit 702. Processor circuit 702 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 702 may execute program code stored in a computer readable medium, such as program code of operating system 730, application programs 732, other programs 734, etc. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random access memory (RAM) 710. A basic input/output system 712 (BIOS) is stored in ROM 708.

Computing device 700 also has one or more of the following drives: a hard disk drive 714 for reading from and writing to a hard disk, a magnetic disk drive 716 for reading from or writing to a removable magnetic disk 718, and an optical disk drive 720 for reading from or writing to a removable optical disk 722 such as a CD ROM, DVD ROM, or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 730, one or more application programs 732, other programs 734, and program data 736. Application programs 732 or other programs 734 may include, for example, computer program logic (e.g., computer program code or instructions) for implementing embodiments described herein, such as but not limited to, system 100 of FIG. 1, system 200 of FIG. 2, system 400 of FIG. 4, and system 600 of FIG. 6, along with any components and/or subcomponents thereof, as well as the flowcharts/flow diagrams described herein, including portions thereof, and/or further examples described herein.

A user may enter commands and information into the computing device 700 through input devices such as keyboard 738 and pointing device 740. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 702 through a serial port interface 742 that is coupled to bus 706, but may be connected by other interfaces, such as a parallel port, game port, or a universal serial bus (USB).

A display screen 744 is also connected to bus 706 via an interface, such as a video adapter 746. Display screen 744 may be external to, or incorporated in computing device 700. Display screen 744 may display information, as well as being a user interface for receiving user commands and/or other information (e.g., by touch, finger gestures, virtual keyboard, etc.). In addition to display screen 744, computing device 700 may include other peripheral output devices (not shown) such as speakers and printers.

Computing device 700 is connected to a network 748 (e.g., the Internet) through an adaptor or network interface 750, a modem 752, or other means for establishing communications over the network. Modem 752, which may be internal or external, may be connected to bus 706 via serial port interface 742, as shown in FIG. 7, or may be connected to bus 706 using another interface type, including a parallel interface.

As used herein, the terms “computer program medium,” “computer-readable medium,” “computer-readable storage medium,” and “computer-readable storage device,” etc., are used to refer to physical hardware media. Examples of such physical hardware media include the hard disk associated with hard disk drive 714, removable magnetic disk 718, removable optical disk 722, other physical hardware media such as RAMs, ROMs, flash memory cards, digital video disks, zip disks, MEMs, nanotechnology-based storage devices, and further types of physical/tangible hardware storage media (including memory 720 of FIG. 7). Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 732 and other programs 734) may be stored on the hard disk, magnetic disk, optical disk, ROM, RAM, or other hardware storage medium. Such computer programs may also be received via network interface 750, serial port interface 742, or any other interface type. Such computer programs, when executed or loaded by an application, enable computing device 700 to implement features of embodiments discussed herein. Accordingly, such computer programs represent controllers of the computing device 700.

Embodiments are also directed to computer program products comprising computer code or instructions stored on any computer-readable medium or computer-readable storage medium. Such computer program products include hard disk drives, optical disk drives, memory device packages, portable memory sticks, memory cards, and other types of physical storage hardware.

### IV. Additional Exemplary Embodiments

A system is described herein. The system includes: at least one processor circuit; at least one memory that stores program code configured to be executed by the at least one processor circuit, the program code comprising: a memory grant engine configured to: determine a predetermined pattern in memory allocations performed for first instances of a query execution plan according to a first memory allocation policy; and a query processor engine configured to: allocate memory space for a second instance of the query execution plan in accordance with a second memory allocation policy; and execute a query of the second instance of the query execution plan in accordance with the memory space allocated in accordance with the second memory allocation policy.

In an embodiment of the system, the memory grant engine is further configured to: determine that an actual amount of memory space required for at least two of the first instances of the query execution plan is greater than memory space allocated for the at least two of the first instances of the query execution plan by a predetermined threshold.

In an embodiment of the system, the memory grant engine is further configured to: determine that an actual amount of memory space required for at least two of the first instances of the query execution plan is less than memory space allocated for the at least two of the first instances of the query execution plan by a predetermined threshold.

In an embodiment of the system, the memory grant engine is further configured to: determine that an actual amount of memory space required for at least one first instance of the query execution plan is less than memory space allocated for the at least one first instance of the query execution plan by a predetermined threshold and an actual amount of memory space required for at least another first instance of the query execution plan is greater than memory space allocated for the at least another first instance of the query execution plan by the predetermined threshold.

In an embodiment of the system, the first memory allocation policy is a last used grant-based policy, in which memory space allocated for a particular instance of the first instances of the query execution plan is based on the actual amount of memory space required for an instance of the first instances of the query execution plan that is prior to the particular instance; and the second memory allocation policy is a percentile grant-based policy, in which memory space allocated for the second instance of the query execution plan is based on a percentile value of the actual amount of memory space required for each of the first instances of the query execution plan.

In an embodiment of the system, the memory grant engine is further configured to: store a value based on at least the amount of memory space allocated for the second instance of the query execution plan in a non-volatile memory.

In an embodiment of the system, the value is further based on a combination of the amount of memory space allocated for the second instance of the query execution plan and a buffer value.

In an embodiment of the system, the memory grant engine is further configured to: determine that memory space allocated for a third instance of the query execution plan in accordance with the second memory allocation policy exceeds the value by a predetermined threshold; update the value based a combination of the amount of memory space allocated for the third instance of the query execution plan and the buffer value; and store the updated value in the non-volatile memory.

A method is also described herein. The method comprises: determining a predetermined pattern in memory allocations performed for first instances of a query execution plan according to a first memory allocation policy; responsive to said determining, allocating memory space for a second instance of the query execution plan in accordance with a second memory allocation policy; and executing a query of the second instance of the query execution plan in accordance with the memory space allocated in accordance with the second memory allocation policy.

In an embodiment of the method, said determining comprises: determining that an actual amount of memory space required for at least two of the first instances of the query execution plan is greater than memory space allocated for the at least two of the first instances of the query execution plan by a predetermined threshold.

In an embodiment of the method, said determining comprises: determining that an actual amount of memory space required for at least two of the first instances of the query execution plan is less than memory space allocated for the at least two of the first instances of the query execution plan by a predetermined threshold.

In an embodiment of the method, the first memory allocation policy is a last used grant-based policy, in which memory space allocated for a particular instance of the first instances of the query execution plan is based on the actual amount of memory space required for an instance of the first instances of the query execution plan that is prior to the particular instance; and the second memory allocation policy is a percentile grant-based policy, in which memory space allocated for the second instance of the query execution plan is based on a percentile value of the actual amount of memory space required for each of the first instances of the query execution plan.

In an embodiment of the method, the method further comprises: storing a value based on at least the amount of memory space allocated for the second instance of the query execution plan in a non-volatile memory.

In an embodiment of the method, the value is further based on a combination of the amount of memory space allocated for the second instance of the query execution plan and a buffer value.

In an embodiment of the method, the method further comprises: determining that memory space allocated for a third instance of the query execution plan in accordance with the second memory allocation policy exceeds the value by a predetermined threshold; updating the value based a combination of the amount of memory space allocated for the third instance of the query execution plan and the buffer value; and storing the updated value in the non-volatile memory.

A computer-readable storage medium having program instructions recorded thereon that, when executed by at least one processing device, perform a method. The method comprises: determining a predetermined pattern in memory allocations performed for first instances of a query execution plan according to a first memory allocation policy; responsive to said determining, allocating memory space for a second instance of the query execution plan in accordance with a second memory allocation policy; and executing a query of the second instance of the query execution plan in accordance with the memory space allocated in accordance with the second memory allocation policy.

In an embodiment of the computer-readable storage medium, said determining comprises: determining that an actual amount of memory space required for at least two of the first instances of the query execution plan is greater than memory space allocated for the at least two of the first instances of the query execution plan by a predetermined threshold.

In an embodiment of the computer-readable storage medium, said determining comprises: determining that an actual amount of memory space required for at least two of the first instances of the query execution plan is less than memory space allocated for the at least two of the first instances of the query execution plan by a predetermined threshold.

In an embodiment of the computer-readable storage medium, the first memory allocation policy is a last used grant-based policy, in which memory space allocated for a particular instance of the first instances of the query execution plan is based on the actual amount of memory space required for an instance of the first instances of the query execution plan that is prior to the particular instance; and the second memory allocation policy is a percentile grant-based policy, in which memory space allocated for the second instance of the query execution plan is based on a percentile value of the actual amount of memory space required for each of the first instances of the query execution plan.

In an embodiment of the computer-readable storage medium, the method further comprises: storing a value based on at least the amount of memory space allocated for the second instance of the query execution plan in a non-volatile memory.

In an embodiment of the computer-readable storage medium, the value is further based on a combination of the amount of memory space allocated for the second instance of the query execution plan and a buffer value.

### V. Conclusion

While various embodiments of the disclosed subject matter have been described above, it should be understood that they have been presented by way of example only, and not limitation. It will be understood by those skilled in the relevant art(s) that various changes in form and details may be made therein without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

What is claimed is:

1. A system, comprising:
at least one processor circuit;
at least one memory that stores program code configured to be executed by the at least one processor circuit, the program code comprising:
a memory grant engine configured to:
determine a predetermined pattern in memory allocations performed for first instances of a query execution plan according to a first memory allocation policy; and
a query processor engine configured to:
allocate memory space for a second instance of the query execution plan in accordance with a second memory allocation policy; and
execute a query of the second instance of the query execution plan in accordance with the memory space allocated in accordance with the second memory allocation policy.

2. The system of claim 1, wherein the memory grant engine is further configured to:
determine that an actual amount of memory space required for at least two of the first instances of the query execution plan is greater than memory space allocated for the at least two of the first instances of the query execution plan by a predetermined threshold.

3. The system of claim 1, wherein the memory grant engine is further configured to:
determine that an actual amount of memory space required for at least two of the first instances of the query execution plan is less than memory space allocated for the at least two of the first instances of the query execution plan by a predetermined threshold.

4. The system of claim 1, wherein the memory grant engine is further configured to:
determine that an actual amount of memory space required for at least one first instance of the query execution plan is less than memory space allocated for the at least one first instance of the query execution plan by a predetermined threshold and an actual amount of memory space required for at least another first instance of the query execution plan is greater than memory space allocated for the at least another first instance of the query execution plan by the predetermined threshold.

5. The system of claim 1, wherein the first memory allocation policy is a last used grant-based policy, in which memory space allocated for a particular instance of the first instances of the query execution plan is based on the actual amount of memory space required for an instance of the first instances of the query execution plan that is prior to the particular instance; and
wherein the second memory allocation policy is a percentile grant-based policy, in which memory space allocated for the second instance of the query execution plan is based on a percentile value of the actual amount of memory space required for each of the first instances of the query execution plan.

6. The system of claim 1, wherein the memory grant engine is further configured to:
store a value based on at least the amount of memory space allocated for the second instance of the query execution plan in a non-volatile memory.

7. The system of claim 6, wherein the value is further based on a combination of the amount of memory space allocated for the second instance of the query execution plan and a buffer value.

8. The system of claim 7, wherein the memory grant engine is further configured to:
determine that memory space allocated for a third instance of the query execution plan in accordance with the second memory allocation policy exceeds the value by a predetermined threshold;
update the value based a combination of the amount of memory space allocated for the third instance of the query execution plan and the buffer value; and
store the updated value in the non-volatile memory.

9. A method comprising:
determining a predetermined pattern in memory allocations performed for first instances of a query execution plan according to a first memory allocation policy;
responsive to said determining, allocating memory space for a second instance of the query execution plan in accordance with a second memory allocation policy; and
executing a query of the second instance of the query execution plan in accordance with the memory space allocated in accordance with the second memory allocation policy.

10. The method of claim 9, wherein said determining comprises:
determining that an actual amount of memory space required for at least two of the first instances of the query execution plan is greater than memory space allocated for the at least two of the first instances of the query execution plan by a predetermined threshold.

11. The method of claim 9, wherein said determining comprises:
determining that an actual amount of memory space required for at least two of the first instances of the query execution plan is less than memory space allocated for the at least two of the first instances of the query execution plan by a predetermined threshold.

12. The method of claim 9, wherein the first memory allocation policy is a last used grant-based policy, in which memory space allocated for a particular instance of the first instances of the query execution plan is based on the actual amount of memory space required for an instance of the first instances of the query execution plan that is prior to the particular instance; and
wherein the second memory allocation policy is a percentile grant-based policy, in which memory space allocated for the second instance of the query execution plan is based on a percentile value of the actual amount of memory space required for each of the first instances of the query execution plan.

13. The method of claim 9, further comprising:
storing a value based on at least the amount of memory space allocated for the second instance of the query execution plan in a non-volatile memory.

14. The method of claim 13, wherein the value is further based on a combination of the amount of memory space allocated for the second instance of the query execution plan and a buffer value.

15. The method of claim 14, further comprising:
determining that memory space allocated for a third instance of the query execution plan in accordance with the second memory allocation policy exceeds the value by a predetermined threshold;
updating the value based a combination of the amount of memory space allocated for the third instance of the query execution plan and the buffer value; and
storing the updated value in the non-volatile memory.

16. A computer-readable storage medium having program instructions recorded thereon that, when executed by at least one processing device, perform a method, the method comprising:
determining a predetermined pattern in memory allocations performed for first instances of a query execution plan according to a first memory allocation policy;
responsive to said determining, allocating memory space for a second instance of the query execution plan in accordance with a second memory allocation policy; and
executing a query of the second instance of the query execution plan in accordance with the memory space allocated in accordance with the second memory allocation policy.

17. The computer-readable storage medium of claim 16, wherein said determining comprises:
determining that an actual amount of memory space required for at least two of the first instances of the query execution plan is greater than memory space allocated for the at least two of the first instances of the query execution plan by a predetermined threshold.

18. The computer-readable storage medium of claim 16, wherein said determining comprises:
determining that an actual amount of memory space required for at least two of the first instances of the query execution plan is less than memory space allocated for the at least two of the first instances of the query execution plan by a predetermined threshold.

19. The computer-readable storage medium of claim 16, wherein the first memory allocation policy is a last used grant-based policy, in which memory space allocated for a particular instance of the first instances of the query execution plan is based on the actual amount of memory space required for an instance of the first instances of the query execution plan that is prior to the particular instance; and
wherein the second memory allocation policy is a percentile grant-based policy, in which memory space allocated for the second instance of the query execution plan is based on a percentile value of the actual amount of memory space required for each of the first instances of the query execution plan.

20. The computer-readable storage medium of claim 16, the method further comprising:
storing a value based on at least the amount of memory space allocated for the second instance of the query execution plan in a non-volatile memory.
